(19) United States
(12) Patent Application Publication
(10) Pub. No.: US 2019/0294804 A1
(43) Pub. Date: Sep. 26, 2019

(54) ENCRYPTED RECORDINGS OF MEETINGS BETWEEN INDIVIDUALS

(71) Applicant: CA, Inc., New York, NY (US)

(72) Inventors: Guy A. Di Lella, San Francisco, CA (US); Maria C. Velez-Rojas, Santa Clara, CA (US); Steven L. Greenspan, Scotch Plains, NJ (US); Serge Mankovskii, Morgan Hill, CA (US); Howard A. Abrams, San Mateo, CA (US); Navid Nader-Rezvani, Los Altos, CA (US); Mark Jacob Addleman, Oakland, CA (US); Otto Gabriel Berkes, Bedford Hills, NY (US); Paul Louis Pronsati,, JR., Golden, CO (US)

(21) Appl. No.: 15/934,736

(22) Filed: Mar. 23, 2018

(51) Int. Cl. G06F 21/60

(52) U.S. Cl. CPC G06F 21/602; G06Q 10/10

(57) ABSTRACT

Techniques are disclosed relating to a computer system receiving recordings of meetings between individuals, encrypting the recording, storing the encrypted recording, and determining whether to decrypt the encrypted recording based on decryption information indicative of ones of the individuals have assented to the decryption of the encrypted recording and a cryptographic policy. The computer system may also perform semantic analysis of the audio of the meeting to identify decision statements made at the meeting and factor statements made at the meeting upon which the decision statement is based. The computer system may also store meeting metadata associated with the meeting that is indicative of the decision statement and factor statements. Subsequent to the meeting, the computer system may reevaluate one or more factor statements, determine encrypted recordings corresponding to the reevaluated factor statements, and output an identification of the decision statements associated with the determined encrypted recordings.

### BACKGROUND

### Technical Field

This disclosure relates generally to the processing of recordings of meetings between individuals, including encrypting and decrypting such recordings.

### Description of the Related Art

Depending on the size of the enterprise, the various employees and contractors of a company may engage in any of a number of meetings on a day-to-day basis. Recordings of one or more meetings may be made to, for example, document what was discussed at the meetings and whether any decisions were made. Some recordings of meetings may be stored securely and made available for subsequent review. If an enterprise engages in a large number of meetings, keeping track of the decisions reached at the various meetings and what factors impacting the decisions were discussed at the meetings can be a complex task.

### SUMMARY

In an embodiment, a method comprises storing, by a computer system, an encrypted recording of at least a portion of a meeting between a plurality of individuals, wherein ones of the plurality of individuals have previously been identified by the computer system, and wherein the encrypted recording was encrypted according to a cryptographic policy. The method further comprises receiving, at the computer system, decryption information indicative of ones of the plurality of individuals that have assented to decryption of the encrypted recording. The method also comprises determining, by the computer system based on the decryption information and the cryptographic policy, that the encrypted recording is to be decrypted; and in response to the determining, decrypting the encrypted recording.

In another embodiment, a non-transitory, computer-readable medium stores instructions that when executed by a computer system cause the computer system to perform operations that comprise receiving, at the computer system, a recording of at least a portion of a meeting between a plurality of individuals, wherein the recording includes audio; and performing, with the computer system, a semantic analysis of the recording to identify a decision statement and one or more factor statements made at the meeting, wherein the semantic analysis indicates that the decision statement is based on the one or more factor statements. The operations further comprise encrypting, with the computer system, the recording according to a cryptographic policy; and storing, by the computer system, the encrypted recording. The operations also comprise receiving, at the computer system, decryption information indicative of ones of the plurality of individuals that have assented to decryption of the encrypted recording; and determining, by the computer system based on the decryption information and the cryptographic policy, that the encrypted recording is to be decrypted; and in response to the determining, decrypting the encrypted recording.

In still another embodiment, a method comprises receiving, at a computer system of an enterprise, a recording of at least a portion of a meeting between a plurality of individuals, wherein the recording includes audio. The method further comprises performing, with the computer system, a semantic analysis of the recording to identify a decision statement and one or more factor statements made at the meeting, wherein the semantic analysis indicates that the decision statement is based on the one or more factor statements. The method also comprises encrypting, with the computer system, the recording according to a cryptographic policy and storing, by the computer system, the encrypted recording in an enterprise library that includes a plurality of encrypted recordings associated with other meetings of the enterprise. Such a method further comprises storing, by the computer system, meeting metadata associated with the encrypted recording in a data store that includes meeting metadata associated with a plurality of encrypted recordings associated with other meetings of the enterprise, wherein the meeting metadata is indicative of the decision statement and the one or more factor statements associated with the meeting and analyzing, by the computer system, meeting metadata associated with the plurality of encrypted recordings to determine whether any factor statements associated with the plurality of encrypted recordings have been subsequently been reevaluated. The method further comprises determining, by the computer system, one or more encrypted recordings corresponding to the reevaluated factor statements; and outputting, by the computer system, an identification of the decision statements associated with the determined one or more encrypted recordings.

### BRIEF DESCRIPTION OF THE DRAWINGS

FIG. 1 is a block diagram illustrating an embodiment of a computer system configured to store an encrypted recording of at least a portion of a meeting.

FIG. 2 is an expanded block diagram of the computer system of FIG. 1 in accordance with various embodiments.

FIG. 3 is a block diagram illustrating communication between one or more individuals and the computer system of FIG. 1.

FIG. 4 is a block diagram illustrating an embodiment of a computer system configured to store and reevaluate metadata for a plurality of meetings.

FIG. 5 is a flowchart illustrating an embodiment of an encrypted meeting decryption method in accordance with the disclosed embodiments.

FIG. 6 is flowchart illustrating an embodiment of a meeting analysis, encryption, and decryption method in accordance with the disclosed embodiments.

FIGS. 7A-B are flowcharts illustrating a meeting decision statement reevaluation method in accordance with the disclosed embodiments.

FIG. 8 is a block diagram of an exemplary computer system, which may implement the various components of FIGS. 1, 4, and 5.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “computer system configured to receive a recording” is intended to cover, for example, a computer system has circuitry that performs this function during operation, even if the computer system in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, references to “first” and “second” individuals would not imply a temporal ordering between the two unless otherwise stated.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

As used herein, the word “module” refers to structure that stores or executes a set of operations. A module refers to hardware that implements the set of functions, or a memory storing the set of instructions such that, when executed by one or more processors of a computer system, cause the computer system to perform the set of operations. A module may thus include an application-specific integrated circuit implementing the instructions, a memory storing the instructions and one or more processors executing said instructions, or a combination of both.

### DETAILED DESCRIPTION

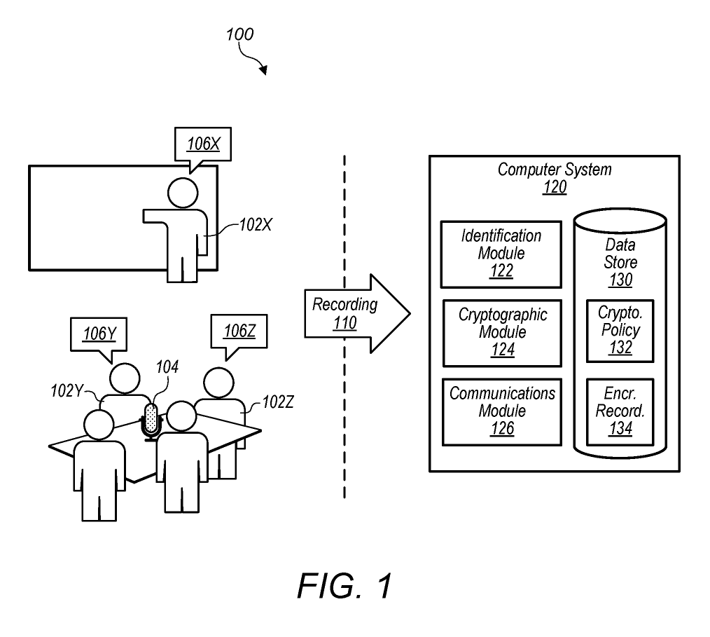

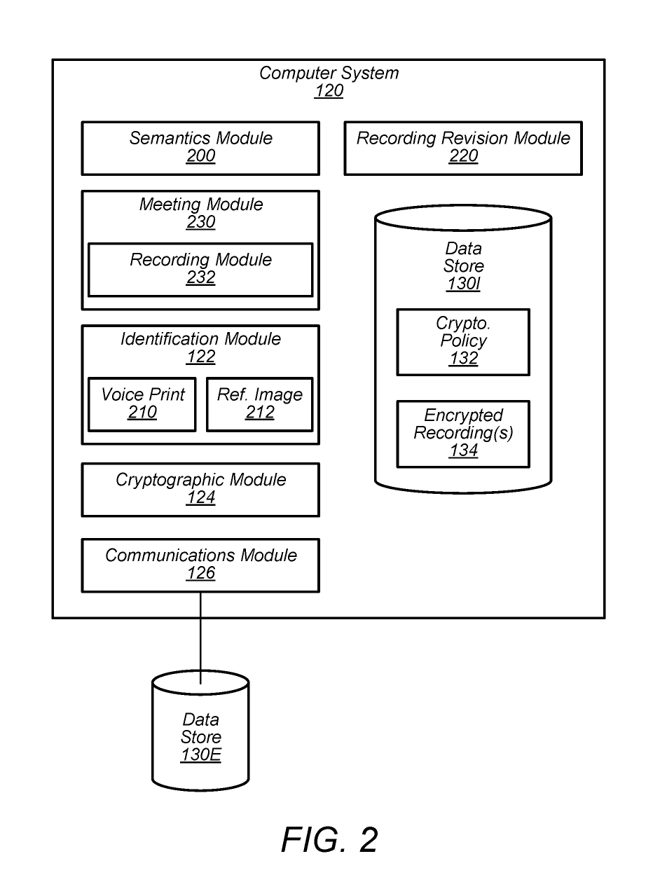

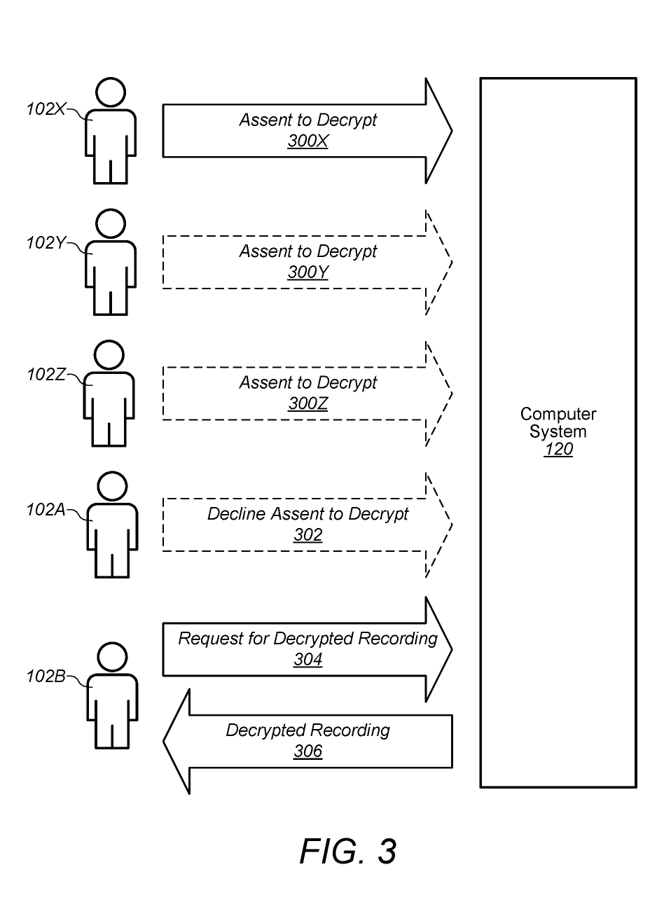

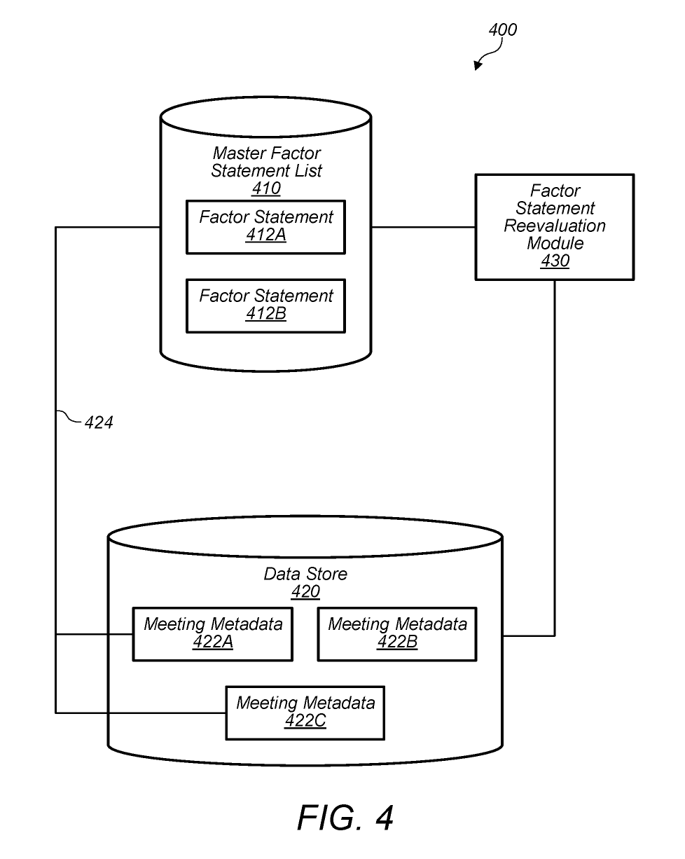

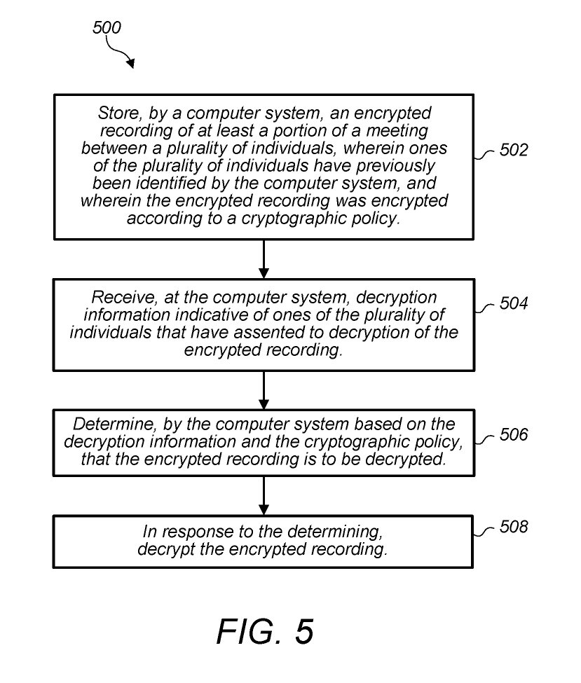

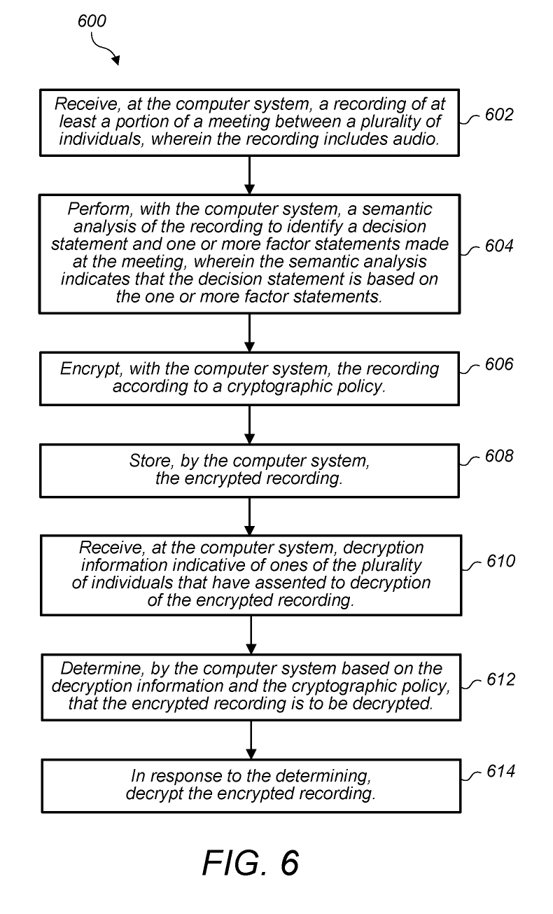

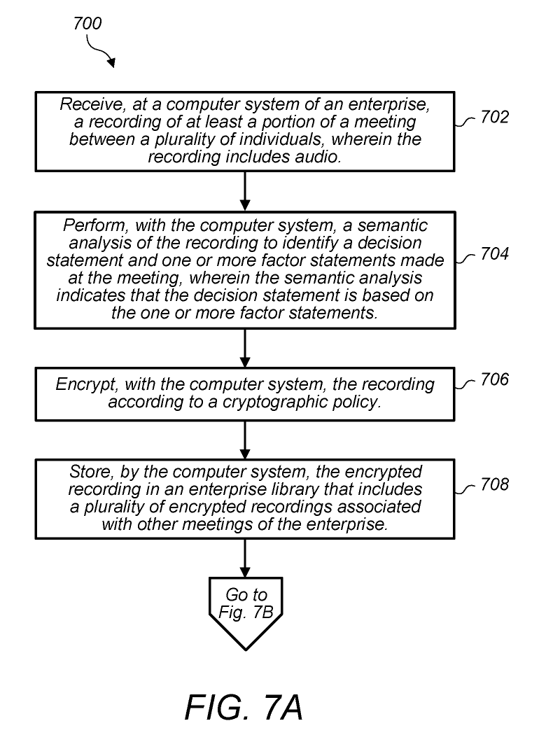

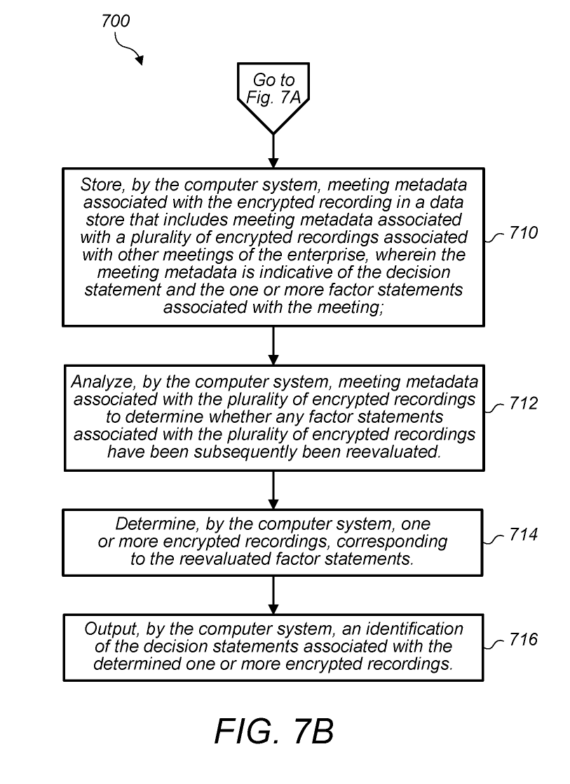

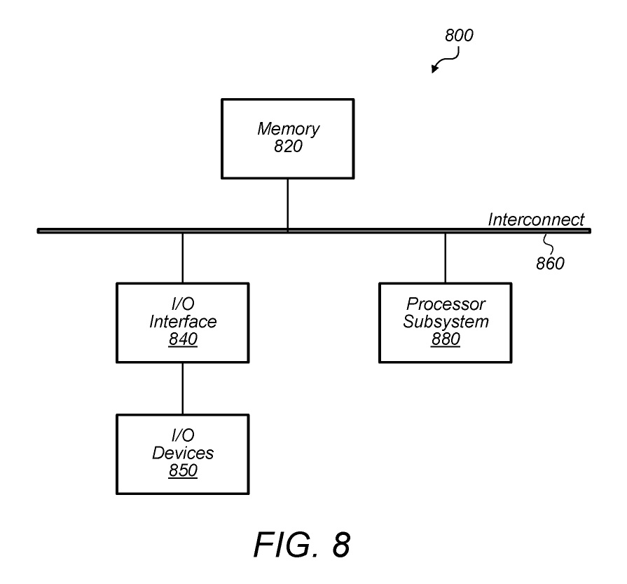

This disclosure describes techniques for recording a meeting between individuals, and securely storing recordings. Embodiments for a meeting, a recording of the meeting, and the computer system on which an encrypted version of the recording is stored are described in reference to FIGS. 1, 4, and 5. Further details relating to the computer system and its communication with individuals are discussed with reference to FIGS. 2 and 3. An exemplary computer system configured to store and reevaluate metadata for a plurality of meetings is discussed with reference to FIG. 4. Further details relating to the encrypted meeting decryption process are described with reference to FIG. 5 and further details relating to the meeting analysis, encryption, and decryption method are described with reference to FIG. 6. An exemplary meeting decision statement reevaluation method is described with reference to FIGS. 7A and 7B. Finally, an exemplary computer system, which may implement the various components of FIGS. 1, 2, and 4 is discussed with reference to FIG. 8.

Referring now to FIG. 1, a block diagram of an exemplary embodiment of a computer system 120 configured to store an encrypted recording of at least a portion of a meeting 100 is depicted. During meeting 100, at least a portion of the discussion is recorded, and in various embodiments, the recording 110 is transmitted to computer system 120.

Meeting 100 occurs between a plurality of individuals 102. In various embodiments, meeting 100 may be an in-person meeting between individuals 102, a telephonic meeting between individuals 102, an online meeting between individuals (e.g., occurring over VOIP, occurring over a video conferencing service such as Skype®, Google®, or Facebook®), or a combination. The plurality of individuals 102 may be physically in the same location (e.g., in a conference room), may be in different, remote locations (e.g., at the individuals' 102 various offices), or a combination where some individuals 102 are in the same location but others are remote (e.g., a group of individuals 102 are meeting in a conference room in California with other individuals calling into the meeting from Texas and British Columbia). Meeting 100, for example, may be an in-person meeting (e.g., taking place in an office, conference room, etc.) where an individual 102X is presenting information to other individuals including individuals 102Y and 102Z as shown in FIG. 1.

Individuals 102 are any of a number of people who are attending meeting 100 (either in-person or remotely). At meeting 100, the individuals 102 make a number of statements 106. In various embodiments, statement 106 is a vocalization by an individual 102 (e.g., spoken in an in-person meeting, spoken on in a telephonic meeting), but statement 106 may be any of a number of communications from an individual 102 including but not limited to vocalizations, written messages, sign language, electronic messages, etc.

Recording device 104 is any of a number of devices that are configured to make a recording 110 of meeting 100. In various embodiments, recording device 104 includes a microphone and records the audio of meeting 100. In such embodiments, recording device 104 may comprise a dedicated recording device 104 or a general-purpose device such as a laptop or cellular phone used as a recording device 104. In various embodiments, recording device 104 relays signals based on the audio of the meeting to software (e.g., running on a computer, server, or plurality of servers) that packages the signals into recording 110. In various embodiments, there may be a plurality of recording devices 104 that work together to create recording 110 (e.g., by using multiple microphones that are mixed together in recording 110, by using multiple general-purpose devices running recording software whose signals are mixed together in recording 110).

In addition to recording audio, in various embodiments recording device 104 may record images or video of meeting 100 (e.g., with one or more cameras filming ones of the individuals 102, one or more conference rooms in which meeting 100 is occurring, etc.) and may record images or video of material presented at meeting 100 (e.g., a recording the material an individual 102 is sharing from his or her computer, a presentation one or more individuals 102 is giving to other individuals 102 in meeting 100). In various embodiments, recording device 104 may also record indications of electronic files viewed, revised, or generated during the meeting (e.g., a spreadsheet, text document, presentation, etc.). In such embodiments, these indications may include links to the electronic files (e.g., links to the document on a server or cloud of servers) or the electronic files themselves. In some embodiments where individuals 102 can make statements 106 (e.g., written statements to the general audience of meeting 100, private messages between individuals 102 attending meeting 100) through a chat feature in meeting software, recording device 104 may also record any or all statements 106 made using such a chat features. Accordingly, in various embodiments, recording device 104 includes one or more devices (e.g., microphones, cameras, computer screen capturing software) configured to record one or more of audio information associated with meeting 100, visual information associated with meeting 100, and electronic transmission information associated with meeting 100.

Recording 110 includes the various information captured by recording device 104 of at least a portion of meeting 100. In various embodiments, recording 110 includes audio information (e.g., vocally-spoken statements 106 from individuals 102). In some of such embodiments, recording 110 includes visual information (e.g., images, video, electronic messages, presentations given at meeting 100). Encrypted recordings 134 generated from recording 110 may similarly include audio information and/or video information that has been encrypted according to the cryptographic policy 132.

In the embodiment depicted in FIG. 1, computer system 120 includes an identification module 122, a cryptographic module 124, a communications module 126, and a data store 130. While only one of each of the identification module 122, cryptographic module 124, communications module 126, and data store 130 are shown in FIG. 1, it will be understood that in various embodiments, computer system 120 may include more than one of some or all of these components (e.g., two data stores 130) and that the various components each may be implemented using hardware, software, or a combination of the two. Data store 130 stores a cryptographic policy 132, and an encrypted recording 134 that is a version of recording 110 that has been encrypted according to cryptographic policy 132. Identification module 122, cryptographic module 124, communications module 126, data store 130, cryptographic policy 132, and encrypted recording 134 are discussed in further detail in reference to FIG. 2 herein.

Computer system 120 is configured to receive recording 110 (e.g., with communications module 126). Computer system 120 is configured to store an encrypted version of recording 110 encrypted according to cryptographic policy 132 as encrypted recording 134 in data store 130. Computer system 120 is configured to receive (e.g., with communications module 126) decryption information indicative of ones of the plurality of individuals 102 that have assented to decryption of the encrypted recording 134. Computer system 120 is configured to determine, based on received decryption information and the cryptographic policy 132, whether to decrypt encrypted recording 134, and having determined that encrypted recording 134 is to be decrypted, computer system 120 is configured to decrypt the encrypted recording.

In various embodiments, individuals 102, for example, may be employees and contractors working for the same company. Among the plurality of individuals 102, there may be a number of key individuals 102 (e.g., higher ranking employees, officers, directors, owners, of the company). In embodiments where the plurality of individuals 102 arrive at a decision at meeting 100, in some embodiments one or more of these key individuals 102 must agree to the decision for the decision to be implemented. For example, in a meeting 100 among a director of engineering and her direct reports discussing the design of a widget and whether to build a prototype, it may be the case that the director must agree to the design of the widget before the prototype is built. In the embodiment depicted in FIG. 1, five individuals 102 are attending meeting 100 including individual 102X who is giving a presentation, and individual 102Y and key individual 102Z. During meeting 100, the various individuals 102 make statements 106.

In some embodiments discussed herein, the plurality of individuals 102 make one or more decisions at meeting 100 (e.g., to buy 1000 widgets) wherein the one or more decisions are based on one or more factors (e.g., to buy 1000 widgets provided: (a) the widgets pass quality tests, (b) there is customer demand for widgets, and (c) the widget supplier will sell the widgets for $10 or less). As a non-limiting example, in the embodiment depicted in FIG. 1, individual 102X makes statement 106X proposing to buy 1000 widgets, individual 102Y makes statement 106Y noting that the widgets must pass quality tests before being purchased, and individual 102Z makes statement 106Z conditionally approving the purchase of 1000 widgets provided the widgets pass the quality tests. These statements 106 are discussed in further detail herein in connection to FIGS. 4, 7A, and 7B.

As part of attending meeting 100, individuals 102 (including individuals 102 physically present at meeting 100 and remotely-located individuals 102) may access meeting software (e.g., discussed herein in reference to meeting module 230 on FIG. 2) that presents video signals to the remotely-located individuals 102 and/or allows projection in a conference room, allows individuals 102 to project information on the individuals' 102 screen (e.g., by “sharing” their screen) to visually present information, and may be in communication with or a part of recording device 104 discussed herein.

In various embodiments, recording 110 includes several streams of information synched together. Recording 110 may include a timeline that may be used to correlate various information recorded by recording devices 104 together. Thus, in various embodiments, visual (e.g., recorded with a camera, recorded with a computer screen recorder) information is synced to the audio (e.g., recorded with a microphone) information such that a video of an individual 102 speaking is synced to the audible sounds of the individual's 102 voice) and/or a video of the information an individual 102 shared using his or her computer is synced to audio of the individual 102 speaking about the shared information. In embodiments, multiple sources of audio and/or video may be mixed together in recording 110. In some embodiments, for example, the audio from individual 102X may be recorded with a first recording device 104 (e.g. a microphone worn by individual 102X) and individuals 102Y and 102Z may be recorded with a second recording device 104 (e.g., a microphone on the table). These different audio sources may be mixed together into a single audio track, or they may be kept on separate tracks and synced up when the recording 110 is played back. Additionally, recording 110 may include visual information from multiple camera angles recorded in separate video feeds that may be played back separately or simultaneously. Electronic information such as visual signals showing information an individual 102 is sharing from a computer or a record of chat information may also be recorded separately synced to the other audio and/or visual information in recording 110.

In some embodiments, recording 110 includes a transcript of meeting 100. In such examples, the transcript is a written record of the words spoken during some of all of meeting 100. Such a transcript may be recorded in the same language(s) as the words spoken during the meeting, or it may be translated into one or more languages. Such a transcript may be made by an individual 102 (e.g., a stenographer) or by speech-to-text software configured to analyze audio information in recording 110 and determine the words spoken by individuals 102. In various embodiments, speech-to-text conversion occurs in real-time as the audio information is recorded. Alternatively, such speech-to-text conversion may be performed after meeting 100 is concluded. The transcript may be synced to the rest of recording 110 (e.g., showing timestamps of the time and date when various statements 106 were made during meeting 100). Recording 110 is sent to computer system 120 in real-time as meeting 100 is ongoing or after meeting 100 is over.

Accordingly, the embodiments depicted in FIG. 1 enable various individuals 102 to engage in meetings 100 and record what was discussed at meeting 100. The recording 110 may include the words spoken during the meeting as well as additional context such as images, videos, transcripts, translations, etc. These recordings 110 may be stored securely on computer system 120 for future retrieval as discussed herein.

Referring now to FIG. 2, an expanded block diagram of the computer system 120 of FIG. 1 is depicted in accordance with various embodiments. In addition to identification module 122, cryptographic module 124, communications module 126, and data store 130 shown in FIG. 1, the computer system 120 depicted in FIG. 2 further includes a semantics module 200, recording revision module 220, and meeting module 230.

Identification module 122 is configured to determine the identities of the various individuals 102 attending meeting 100. In various embodiments, identification module 122 is configured to determine the identities of individuals 102 by one or more of requesting that the various individual 102 identify themselves, analyzing audio and recognizing the various voices of individuals 102, and analyzing video or images and recognizing the images of the face or other body parts of the individuals 102. In some of such embodiments, identification module 122 is configured to request that the various individual 102 identify themselves by requesting that the individuals present a credential associated with themselves (e.g., user login and password, biometric identification, voiceprint identification) and/or a credential associated with a computer (e.g., a code or token stored on a laptop computer, desktop computer, tablet computer, smart phone) associated with the individual 102 or another device associated with the individual (e.g., a changing number generated by a security token device, a code or token stored on an identification badge). In various embodiments, identification module 122 requests that individuals 102 identify themselves before joining meeting 100 (e.g., by requiring individuals 102 to log in to meeting software before joining meeting 100, by requesting the individual 102 speak his or her name before joining meeting 100, by requiring a roll call of individuals 102 attending meeting 100 before meeting 100 begins).

In other embodiments, identification module 122 is configured to identify individuals 102 based on their voice and/or image. In embodiments where identification module 122 identifies individuals 102 by voice, identification module 122 may be configured to store voice prints 210 associated with the various individuals' 102 profiles such that when a voice of an individual 102 in recording 110 is compared to the individual's voice print 210, the identification module 122 is able to determine the individual's 102 identity. Similarly, in embodiments where identification module 122 identifies individuals 102 by image, identification module 122 may be configured to store one or more reference images 212 associated with the various individuals' 102 profiles such that when an image of an individual 102 in recording 110 is compared to the individual's reference image 212, the identification module 122 is able to determine the individual's 102 identity.

In various embodiments, once identification module 122 has identified one or more individuals 102 participating in meeting 100, identification module 122 is configured to determine individual portions of a recording 110 in which various identified individuals spoke. For example, identification module 122 may identify first individual portions in which a first identified individual spoke and second individual portions in which a second identified individual spoke. In some embodiments where audio and/or audio and video of various individuals are recorded separately (e.g., recorded with a microphone or camera individually associated with just a particular individual 102), identifying the individual portions may be accomplished by determining portions of meeting 100 where the audio level is above a certain threshold (e.g., the expected volume of a human voice). Additionally or alternatively, an audio recording of meeting 100 may be analyzed and compared to voice prints 210 of various individuals to identify when particular individuals 102 are speaking. Similarly, a video recording of meeting 100 may be analyzed and compared to reference images 212 of various individuals to identity when particular individuals 102 are speaking. In various embodiment, identification module 122 may be configured to perform this identification analysis on the recording 110 before it is encrypted or by decrypting (using the cryptographic module 124) the encrypted recording 134 and performing the identification analysis on the decrypted recording. The results of the identification analysis performed by identification module 122 may be stored (e.g., in a data store 130) as metadata. In various embodiments, such metadata may be used to determine individual portions of encrypted recordings 134 in which particular individuals spoke without needing to decrypt the encrypted recordings 134.

Cryptographic module 124 is configured to perform the cryptographic operations for computer system 120 including encrypting recordings 110 according to the cryptographic policy 132 to generate an encrypted recording 134 and decrypting encrypted recordings 134 according to cryptographic policy 132. The encryption process performed by the cryptographic module 124 may be performed by any of a number of encryption algorithms including but not limited to using private keys or public-private key pairs, tokens, certificates, etc. Once the computer system 120 has determined an encrypted recording 134 is to be decrypted as discussed herein in, the decryption process performed by the cryptographic module 124 may similarly be performed using any of a number of encryption algorithms including but not limited to using private keys or public-private key pairs, tokens, certificates, etc.

As used herein, “cryptographic policy” means one or more rules used to encrypt and decrypt something. In various embodiments, a “cryptographic policy” (e.g., a cryptographic policy 132) includes rules explaining how something is to be encrypted or decrypted (e.g., that a private key algorithm should be used) and rules explaining why something is to be encrypted or decrypted (e.g., the one or more criteria included in cryptographic policy 132 discussed herein). As used herein, a particular individual's 102 “assent” to decryption is an indication that the particular individual 102 has approved decrypting the encrypted recording 134. Assent may be given (or denied) for decrypting a particular encrypted recording 134, may be given using generalized rules (e.g., individual 102Y generally assents to decryption of all encrypted recordings 134 not marked “top secret”), or may be given by a delegate (e.g., a person, software) appointed by individual 102. Individuals 102 may indicate assent to decrypting the recording in any of a number of ways as discussed herein in reference to FIG. 3.

In various embodiments, cryptographic module 124 is configured to decrypt an encrypted recording 134 when one or more criteria specified by the cryptographic policy 132 are satisfied. In various embodiments, a generalized cryptographic policy 132 may specify one or more decryption criteria that apply to multiple encrypted recordings 134, but in some embodiments, some individual encrypted recordings 134 have an individual cryptographic policy 132 associated with it with one or more criteria that different from criterial specified by the generalized cryptographic policy 132. Such criteria may include but are not limited to: (1) that the majority of individuals 102 attending meeting 100 have assented to decryption, (2) that a number of key individuals 102 attending meeting 100 have assented to decryption, (3) that the individual 102 who requested that meeting 100 be recorded has assented to decryption. Accordingly, in some embodiments, the cryptographic policy 132 specifies that a majority of the plurality of individuals 102 who attended meeting 100 must have assented to decryption as a criterion for determining whether to decrypt an encrypted recording 134. In some embodiments, the plurality of individuals 102 attending meeting 100 includes one or more key individuals 102 (e.g., individual 102Z) and the cryptographic policy 132 specifies that one or more of the key individuals 102 who attended meeting 100 must have assented to decryption as a criterion for determining whether to decrypt an encrypted recording 134 of meeting 100. In some embodiments where recording 110 of meeting 100 was created at the request of a first individual 102 of the plurality of individuals 102, the cryptographic policy 132 specifies that the first individual 102 must have assented to decryption as a criterion for the determining whether to decrypt an encrypted recording 134 of the meeting 100.

In some embodiments, the cryptographic module 124 may be configured to decrypt some or all of an encrypted recording 134 after a single criterion has been met, or may require multiple criteria to be met (e.g., a majority of individuals 102 have assented to decryption and at least one key individual 102 has assented to decryption) before decrypting some or all of an encrypted recording 134. In some embodiments, some encrypted recordings 134 (e.g., encrypted recordings 134 marked with a lower level of confidentiality like “confidential”) may be decrypted upon meeting one criterion but other encrypted recordings 134 (e.g., encrypted recordings 134 marked with a higher level of confidentiality like “top secret”) may only be decrypted upon meeting more than one criterion.

In various embodiments, cryptographic module 124 is configured to encrypt portions of recording 110 of meeting 100 but not other portions of the recording 110. In such embodiments, for example, the cryptographic policy 132 may specify that portions of the recording 110 that one or more individuals 102 has marked “confidential” are to be encrypted but other portions are not to be encrypted. In some embodiments, cryptographic module 124 is configured to decrypt some portions of an encrypted recording 134 but not other portions. In some of such embodiments, different portions of encrypted recordings 134 may have different required levels of clearance to access (e.g., less restrictive “confidential” clearance and more restrictive “top secret” clearance). In such embodiments, an individual 102 with lower level clearance (e.g., “confidential” clearance only) may only be permitted to decrypt portions of an encrypted recording 134 marked at a lower level of confidentiality (e.g., portions marked “confidential”) but not portions marked at higher levels of confidentiality (e.g., portions marked “top secret”). In various embodiments, cryptographic module 124 is configured to separately encrypt different tracks of recording 110. In some of such embodiments, separately recorded audio information tracks and visual information tracks may be encrypted separately but stored together as encrypted recording 134. In some of such embodiments, tracks associated with particular ones of various individuals 102 (e.g., tracks associated with individual 102X, tracks associated with individual 102Y) may be encrypted separately but stored together as encrypted recording 134. In such embodiments, tracks associated with particular individuals 102 may be subsequently removed from the encrypted recording 134 without having to decrypt the encrypted recording 134.

In other embodiments, the cryptographic policy 132 may specify that a particular individual's 102 assent to decryption is required to decrypt the portions of an encrypted recording 134 in which that particular individual 102 is speaking. In such embodiments, computer system 120 is configured to determine portions of encrypted recording 134 in which the particular individual 102 is speaking. Having identified these portions of the encrypted recording 134, as part of determining whether to decrypt an encrypted recording 134 including these portions, cryptographic module 124 is configured to determine whether decryption information indicative of whether the particular individual 102 assented to decryption of the encrypted recording 124 has been received. If the particular individual's 102 assent has been received (and in some embodiments whether other required criteria in the cryptographic policy 132 have been met) decrypting the encrypted recording 134 includes decrypting the encrypted version of the portion(s) in which the particular individual 102 spoke. If the particular individual's 102 assent has not been received, in various embodiments cryptographic module 124 may prevent the encrypted recording 134 from being decrypted at all or may decrypt other portions of the encrypted recording 134 but not decrypt the encrypted version of the portion(s) in which the first individual 102 spoke.

In various embodiments, cryptographic module 124 uses a blockchain-based shared ledger to encrypt recording 110 and to decrypt encrypted recording 134. In such embodiments, the shared ledger may be used to authenticate user (e.g., individuals 102, other parties) requesting to decrypt encrypted recordings 134, note any successful decryptions or changes to encrypted recordings, provide cryptographic keys to encrypt recording 110 and decrypt encrypted recordings 134. In some of such embodiments, particular individuals 102 have computer systems 120 (e.g., laptop computers, desktop computers, tablet computers, smartphones) associated with them and that are configured to validate the blockchain-based shared ledger before transmitting decryption information (e.g., a message 300 or 302 in reference to FIG. 3) from the particular individual 102 indicative of whether the particular individual 102 assents to decryption of the encrypted recording 134. In embodiments discussed herein in which computer system 120 receives a request to change the encrypted recording 134 (e.g., a request to remove a track of audio due to excessive background noise with recording revision module 220 discussed herein), cryptographic module 124 may be configured to evaluate the requested change according to the cryptographic policy 132 and record information about the requested change in the blockchain-based shared ledger. For example, in some embodiments, the cryptographic policy 132 may require that a majority of individuals 102 approve a requested change before the change is made to encrypted recording 134. In such embodiments, if the requested change does not receive approval from the majority of individuals 102, the requested change will not be made, but the requested change will be made if a majority of individuals 102 approve. In some of such embodiments, the requested change, indications of approval or disapproval from individuals 102, and/or whether the change was made are recorded in the blockchain. It will be understood, however, that other than majority approval, in various embodiment cryptographic policy 132 includes different requirements as discussed herein.

Communications module 126 receives messages sent to computer system 120 and sends messages from computer system 120 to facilitate communication. Communications module 126 is configured to receive recordings 110, messages 300, 302, and 304 from individuals 102, and to send decrypted versions of encrypted recordings 134 to a user requesting the decryption. Communications module 126 may include any of a number of wired (e.g., ethernet, USB, etc.) or wireless (e.g., cellular radio, WiFi) communications devices and protocols. In various embodiments, computer system 120 sends and receives communication from local area networks and wide area networks (e.g., the Internet). In various embodiments, communications module 126 is configured to receive input from recording devices 104. In such embodiments, communications module 126 may include one or more audio jacks and/or one or more video jacks. Such audio and/or video jacks may be analog (e.g., a headphone jack) or digital (e.g., an HDMI port). In various embodiments, communications module 126 is configured to receive messages from computer systems associated with various individuals 102 communicating with computer system 120 over a network. For example, communications module 126 may receive messages from meeting software during the meeting including audio information or visual information generated by one or more individuals 102 during meeting 100.

Data store 130 is usable to store program instructions executable by computer system 120 to perform various operations described herein as well as cryptographic policy 132 and encrypted recordings 134. Data store 130 may be implemented using different physical memory media, such as hard disk storage, floppy disk storage, removable disk storage, flash memory, random access memory (RAM-SRAM, EDO RAM, SDRAM, DDR SDRAM, RAIVIBUS RAM, etc.), read only memory (PROM, EEPROM, etc.), and so on. In some embodiments, data store 130 is an internal data store 1301 that is integrated with computer system 120 (e.g., a hard drive disposed within computer system 120). Additionally or alternatively, data store 130 may be an external data store 130E that is remote from other portions of computer system 120 (e.g., distributed storage in a network of servers). In FIG. 2, cryptographic policy 132 and encrypted recordings 134 are stored in internal data store 1301, but in other embodiments cryptographic policy 132 and encrypted recordings 134 may be stored in external data store 130E. Additionally, external data store 130E may be a data store with information relevant to determining whether factor statements should be reevaluated in connection to FIGS. 4, 7A, and 7B.

In various embodiments, semantics module 200 is configured to apply natural language analysis to analyze the audio and textual information of meeting 100 to determine, based on the words said and written during the meeting, what was discussed at meeting 100, what decisions were made, and the factors on which such decisions are based. In various embodiments, semantics module 200 is configured to apply natural language analysis. In some embodiments, for example, semantics module 200 is configured to recognize key phrases such as “we should,” “we decided,” and “because” and analyze the words around these key phrases to determine whether a decision was made and the factors statements on which the decision is based. For example, individual 102X may say “We should buy 1000 widgets because our research shows strong demand for widgets this quarter.” In this example, the decision statement identified by semantics module 200 is “we should buy 1000 widgets” and the semantics module 200 identifies the factor statement on which the decision is based as “because our research shows strong demand for widgets this quarter.” Semantic module 200 may also be configured to analyze visual information synced with audio to determine decisions and factor statements. In the example above, when individual 102X said “We should buy 1000 widgets because our research shows strong demand for widgets this quarter” semantics module 200 may analyze the synced visual information and determine that when 102X made this statement, a presentation slide stating “Projected cost for widgets is $10” and determine that the decision “We should buy 1000 widgets” has an additional factor statement that the widgets cost $10. This determined decision statement and factor statement information may be stored in master factor statement list 410 and data store 420 discussed in connection with FIG. 4 herein.

Recording revision module 220 is configured to configured to modify recordings 110 and/or encrypted recordings 134. In various embodiments, recording revision module 220 is configured to modify recording 110 before it is encrypted and cryptographic module 124 is configured to encrypt the modified recording 110. In other embodiments, recording revision module 220 is configured to modify encrypted recording 134 (e.g., by obtaining a decrypted version of encrypted reporting 134 and modifying the decrypted version).

In various embodiments, modifying the recording 110 and/or encrypted recording 134 includes removing portions of the recording 110 and/or encrypted recording 134 and creating modified version of such recordings. In some embodiments where audio for various individuals 102 is recorded in different audio tracks, for example, recording revision module 220 is configured to remove one or more separate audio tracks from the final mix of the recording 110 and/or encrypted recording 134. In other embodiments, reporting revision module 220 may separate audio information of recording 110 and/or encrypted recording 134 from visual information of recording 110 and/or encrypted recording 134 (e.g., to reduce file size, to remove low quality visual information, to remove inaccurate visual information). In some embodiments where computer system 120 is configured to identify individual portions of recording 110 (and encrypted recording 134), computer system 120 is configured to determine to remove individual portions of a recording 110 and/or encrypted recording 134 associated with a particular individual. After such a determination is made, in some embodiments recording revision module 220 is configured to remove the individual portions from recording 110 and computer system 120 is configured to encrypt the modified recording according to cryptographic policy 132. In other embodiments, after the determination is made, recording revision module 220 is configured to modify encrypted recording 134 to remove the individual portions from the encrypted recording 134 (e.g., by removing separately encrypted tracks associated with particular individuals 102, by obtaining a decrypted version of encrypted recording 134 and revising to remove individual portions) according to the cryptographic policy 132. Removing portions of the recording 110 and/or encrypted recording 134 may be done for any of a number of reasons including but not limited to: removing audio and/or visual information associated with an individual 102 making rude, abusive or offensive statements, removing audio tracks with loud background noise, and removing audio and/or visual information with poor quality (e.g., a low bitrate, poor connection during meeting 100, etc.).

In other embodiments, recording revision module 220 may add information (audio information, visual information, or both) to recording 110 and/or encrypted recording 134 (e.g., by adding visual information synced to the audio information of recording 110 and/or encrypted recording 134). In some of such embodiments, the recording revision module 220 is configured to add visual information relating to a presentation that was given at meeting 100 (e.g., one or more slides or videos shown at meeting 100). In some embodiments, the recording revision module 220 is configured to add (and/or remove) audio or visual information to update, correct, or revise one or more statements 106 made in meeting 100. These embodiments are discussed in further detail in reference to FIG. 4 discussed herein.

In various embodiments, computer system 120 includes meeting module 230. In such embodiments, meeting module 230 is configured to implement the “meeting software” used by some or all of the individuals 102 attending meeting 100. As used herein, “meeting software” refers to software running on a computer system (e.g., computer system 120) locally on a computer associated with an individual 102 and/or remotely on a server or group of servers that facilitates meeting 100 including identifying individuals 102 and allowing individuals 102 to exchange audio, video, and/or electronic message information between one another. For example, individual 102X may give a presentation by accessing meeting software and sharing their screen and individual 102Y and individual 102Z may attend the meeting and watch individual 102X's presentation using meeting software that receives the information individual 102X is sharing from their screen. In various embodiments, meeting module 230 runs the meeting software and remotely displays meeting information on computers associated with the various individuals 102. In various embodiments, meeting module 230 includes a recording module 232 that records meeting 100 by implementing a recording feature in the meeting software. In some of such embodiments, individuals 102 access the recording feature as part of attending meeting 100 (e.g., by accessing meeting software that includes the recording feature), and the recording feature makes a recording 110 of meeting 100 using one or more recording devices 104. In various embodiments, the meeting software may include modules that implement portions of the tasks performed by recording device 104 discussed herein, and the various tasks performed by computer system 120 discussed herein in connection to FIGS. 2, 3, 5, and 6 and computer system 400 discussed herein in connection to FIGS. 4, 7A, and 7B.

A computer system 120, as shown in FIG. 2, may therefore be used to receive a recording 110 (including audio) of at least a portion of a meeting 100 between a plurality of individuals 102 and perform semantic analysis of the recording 110 to identify a decision statement 106 and one or more factor statements 106 made at the meeting. The computer system 120 is then usable to encrypt the recording 110 according to cryptographic policy 132 and securely store the resulting encrypted recording 134 along with metadata reflecting the semantic analysis. In various embodiments, computer system 120 may also identify various individuals 102 attending meeting 100 before or subsequent to encrypting recording 110. Subsequent to storing encrypted recording 134, computer system 120 receives decryption information (discussed in further detail herein in connection to FIG. 3) indicative of ones of the plurality of individuals 102 that have assented to decryption of the encrypted recording 134 and determines based on the decryption information and the cryptographic policy 132, whether encrypted recording 134 is to be decrypted. If computer system 120 determines that encrypted recording 134 is to be decrypted, computer system decrypts the encrypted recording 134. This decrypted version of encrypted recording 134 may be played back or otherwise sent to an entity that has requested the decrypted version (e.g., an individual 102, a person who did not attend meeting 100, a computer program, etc.).

Referring now to FIG. 3, a block diagram illustrating communication between one or more individuals 102 and the computer system 120 is depicted. In various embodiments, individuals 102 may send a message 300 indicating assent by the individual 102 to decrypt the encrypted, a message 302 indicating that the individual does not assent to decryption, and/or a message 304 requesting a portion of a decrypted recording. After computer system 120 has determined that the encrypted recording is to be decrypted as discussed herein, computer system 120 sends decrypted recording 306 to one or more individuals 102.

Message 300 is a message sent by (or on the behalf of) a particular individual 102 indicating that the particular individual 102 assents to the decryption of an encrypted recording 134 for a particular meeting 100. In various embodiments, the message 300 is an electronic message sent from a computer system (not shown) associated with the individual 102 (e.g., a desktop computer, laptop computer, smart phone, tablet computer, wearable computing device, etc.). In other embodiments, a particular individual 102 may communicate assent to decrypting the meeting via an intermediary (e.g., a secretary, assistant) who may send a message 300 indicating the particular individual's assent to decrypting the encrypted recording 134. In various embodiments, message 300 may be a message sent on behalf of a group of individuals 102 indicating whether each of the group of individuals 102 assents to the decryption of an encrypted recording 134 for a particular meeting 100.

Message 302 is a message sent by (or on the behalf of) a particular individual 102 indicating that the particular individual 102 does not assent to the decryption of an encrypted recording 134 for a particular meeting 100. In various embodiments, the message 302 is an electronic message sent from a computer system (not shown) associated with the individual 102 (e.g., a desktop computer, laptop computer, smart phone, tablet computer, wearable computing device, etc.). In other embodiments, a particular individual 102 may communicate that he or she does not assent to decrypting the encrypted recording 134 via an intermediary (e.g., a secretary or assistant) who may send a message 302 indicating that particular individual does not assent to decrypting the encrypted recording 134. In various embodiments, message 302 may be a message sent on behalf of a group of individuals 102 indicating that each of the group of individuals 102 does not assent to the decryption of an encrypted recording 134 for a particular meeting 100. Some messages 300 and 302 may be combined such that the combined message indicates that some individuals 102 assent to decryption and other individuals do not assent to decryption. In various embodiments, such a combined message, for example, is the results of a vote taken among the individuals 102 at meeting 100 or subsequent to meeting 100.

In various embodiments, one or more individuals 102 may appoint a delegate to assent or not assent to decryption of encrypted recording 134. In some embodiments the delegate is a person such as a secretary or assistant who has been appointed by an individual 102 to decide whether to assent or not assent to decryption of encrypted recording 134 on the individual 102's behalf. In some embodiments, the delegate is a software (e.g., a bot). Such software may follow generalized rules (e.g., assent to decryption of all encrypted recordings 134 not marked “top secret”; assent to decryption of an encrypted recording 134 for a meeting 100 relating to marketing) and/or use machine-learning to predict whether the individual 102 would assent or not assent to decryption of the encrypted recording 134. Such a machine-learning-based decision may be based, for example, on the subject matter of meeting 100 (e.g., assent to decryption of an encrypted recording 134 for a meeting 100 relating to marketing; not assent to decryption of an encrypted recording 134 for a meeting 100 relating to mergers and acquisitions); the individuals 102 attending meeting 100 (e.g., assent to decryption of an encrypted recording 134 for a meeting 100 attended by the individual's 100 direct reports; not assent decryption of an encrypted recording 134 for a meeting 100 attended by the CEO of the enterprise); key words spoken in the meeting; or a combination. In various embodiments, software acting as a delegate can summarize statements 106 made by individual 102 at meeting 100 (e.g., using natural speech processing and natural speech generation algorithms).

In some embodiments, computer system 120 is configured to assume that individuals 102 do not assent to encryption unless the various individuals 102 respond with messages 300 indicating that the particular individual 102 assents to the decryption of an encrypted recording 134 for a particular meeting 100. Accordingly, in some embodiments, computer system 120, as a default, does not allow decryption of encrypted recording 134 until messages 300 indicating assent to decryption sufficient to meet one or more criteria of the encryption policy 132 are satisfied. In other embodiments, however, computer system 120, as a default, allows decryption of encrypted meeting 134 until messages 302 indicating that one or more individuals 102 do not assent to decryption of encrypted recording 134 are received. In various embodiments, for example, this may allow an individual 102 to veto decryption of encrypted recording 134 or may allow a group of individuals 102 to vote to not let encrypted recording 134 be decrypted.

Message 304 is a is a request sent by (or on the behalf of) a particular individual 102 for a decrypted version of an encrypted recording 134 for a particular meeting 100. While FIG. 3 shows message 304 is sent by (or on the behalf of) individual 102 (i.e., an individual who attended meeting 100), such a message 304 may be sent by another entity such as a person who did not attend meeting 100 or a computer program. In various embodiments, the message 304 is an electronic message sent from a computer system (not shown) associated with the requester (e.g., a desktop computer, laptop computer, smart phone, tablet computer, wearable computing device, etc.

The messages 300, 302, and 304 may be encoded in any of a number of known ways (e.g., an email, SMS message, selection on a webform). The messages 300, 302, and 304 may be sent in accordance with a security protocol requiring, for example, verification of the particular individual's identity (e.g., a user login and password, biometric indicator) and/or techniques to secure the content of the message 300, 302, and 304 (e.g., by encrypting the message 300).

If computer system 120 determines to decrypt an encrypted recording 134 for a particular meeting 100 (e.g., by determining whether one or more criteria specified by the cryptographic policy 132 are met), computer system 120 sends the decrypted recording 306 to the requester (e.g., individual 102B). In various embodiments, computer system 120 may send decrypted recording 306 (in one or more portions) to a computer associated with the requester for storage on the computer and/or to stream on the computer. In various embodiments, the requestor sends message 304 via meeting software and receives decrypted recording 306 via the meeting software.

In FIG. 3, five individuals are depicted individuals 102X, 102Y, 102Z, 102A, and 102B, although any number of individuals 102 may interact with computer system 120 (and attend meeting 100) as discussed herein. In the embodiment depicted in FIG. 3, however, individuals 102X, 102Y, and 102Z have assented to the decryption of an encrypted recording 134 of a particular meeting 100, and individual 102A has affirmatively not assented to decryption. In embodiments where the cryptographic policy 132 specifies that a majority of the plurality of individuals 102 must have assented to decryption as a criterion for decryption, this criterion has been met by three out of five individuals 102 indicating assent to decryption. However, in embodiments where the cryptographic policy 132 specifies that all of the plurality of individuals 102 must have assented to decryption as a criterion for decryption, this criterion has not been met because individuals 102A and individuals 102B have not indicated assent to decryption. In embodiments where the cryptographic policy 132 specifies that one or more of the key individuals 102 must have assented to decryption as a criterion for decryption, this criterion has also been met by key individual 102Z indicating assent to decryption. In embodiments where the individual 102X requested that the meeting 100 be recorded and cryptographic policy 132 specifies that the assent of the individual 102 who created the meeting 100 be recorded as a criterion for decryption, this criterion has also been met because individual 102X has assented to decryption. As discussed herein, in various embodiments one or more of these criteria must be met as a condition for computer system 120 determining to decrypt the encrypted recording 134 of a particular meeting 100. In the embodiment shown in FIG. 3, at least one of these criteria has been met, and therefore computer system 120 sends decrypted recording to the requester: individual 102B.

In addition to securely storing encrypted recordings 134 of meetings 100 and making such encrypted recordings 134 available based on received decryption information and the cryptographic policy 132, stored information about the meetings 100 may be analyzed and reevaluated subsequent to the occurrence of such meetings 100. Referring now to FIG. 4, a block diagram illustrating an embodiment of a computer system 400 configured to store and reevaluate metadata for a plurality of meetings 100 is shown. In the depicted embodiment, computer system 400 includes a master factor statement list 410, a data store 420, and a factor statement reevaluation module 430. In various embodiments, computer system 400 may be implemented on the same hardware as computer system 120 (e.g., on the same computer server or network of computer servers). In other embodiments, computer system 400 and computer system 120 are implemented on different hardware (e.g., two separate networks of computer servers) that are in communication and work together. Computer system 400 (and computer system 120 to which computer system 400 is integrated or coupled) may be associated with an enterprise. As discussed herein, in various embodiments computer system 400 (with computer system 120) is capable of storing encrypted recordings 134, factor statements 412, and metadata 422 associated with thousands (or more) meetings 100 attended by thousands (or more) individuals 102.

Master factor statement list 410 includes a number of factor statements 412. FIG. 4 depicts factor statement 412A and factor statement 412B, but master factor statement list 410 may store any number of factor statements 412 (e.g., hundreds, thousands, millions). In various embodiments, factor statements 412 are determined by the semantic analysis (e.g., performed with semantics module 200 discussed herein) of recordings 110 and/or encrypted recordings 134 stored by computer system 120. As discussed herein, the semantics analysis may determine decisions and factor statements 412 on which the decisions were made based on the statements 106 made by individuals during meeting 100. While one factor statement list 410 is shown in FIG. 4, in various embodiments, multiple factor statement lists may be used.

In some embodiments, factor statements 412 may be categorized into “factual statements” that are clearly verifiable or falsifiable. For example, the factor statement 412 “if widgets cost $10 or less” is a factual statement because either widgets cost $10 or less or they do not. Other factor statements 412 may be categorized as “research requests” in which an individual 102 makes a statement 106 asking computer system 120 or 400 to determine a responsive query to the request. For example, an individual 102 might say “Computer, please insert the price of widgets in six months into the record of this meeting. The decision to purchase widgets is partly dependent upon the current price of widgets in six months.” In response to this request, the factor statement 412 “price of widgets in six months” may be stored in master factor statement list 410 and the research request fulfilled as discussed herein. Factor statements 412 may also be categorized as not clearly verifiable or falsifiable (e.g., opinions). In various embodiments, factor statements 412 may be categorized into one or more subject matter categories including but not limited to: legal/regulatory factor statements, financial factor statements, technical factor statements, organizational capacity factor statements, and market factor statements.

In various embodiments, data store 420 stores a number of meeting metadata 422 objects. FIG. 4 depicts meeting metadata 422A, 422B, and 422C, but data store 420 may store any number of meeting metadata 422 objects (e.g., hundreds, thousands, millions). In various embodiments, meeting metadata 422 includes information about when and where meeting 100 took place, the individuals 102 attending meeting 100, and what statements 106 were made at meeting 100. In various embodiments, meeting metadata 422 includes records indicative of statements 106 showing one or more decisions made at meeting 100 and one or more factor statements (e.g., factor statements 412) on which such decisions are based. In various embodiments, meeting metadata 422 is associated with factor statement 412 stored on the master factor statement list 410 as shown by association 424. In embodiments, meeting metadata 422 is associated with one or more factor statement 412 because meeting metadata 422 for a particular indicates that the associated factor statement 412 was a factor statement discussed in the particular meeting 100 and a decision made in the particular meeting was based on the associated factor statement(s) 412. In embodiments, association 424 is implemented using references stored in meeting metadata 422 to specific factor statements 412 in master factor statement list 410. As shown in FIG. 4, meeting metadata 422A for a first meeting and meeting metadata 422C for a third meeting indicate that one or more decisions made in the first meeting and the second meeting were based on factor statement 412A.

Factor statement reevaluation module 430 is configured to reevaluate factor statements 412 stored in master factor statement list 410, determine which (if any) decision(s) made in which meeting(s) 100 should be reevaluated because a factor statement 412 on which the decision(s) were made was reevaluated, determine which (if any) encrypted recording(s) 134 are associated with decisions determined to be reevaluated, and to output an identification of the decision(s) statements to be reevaluated to the appropriate individuals 102. In various embodiments, subsequent to meeting 100, factor statement reevaluation module 430 analyzes one or more data stores and determines that one or more factor statements 412 should be revised. These data stores may include but are not limited to data stores including sales data, weather data, financial data, legal/regulatory data, price data, market data, organizational capacity data, etc. In various embodiments, having identified one or more decisions to be reevaluated, factor statement reevaluation module 430 records an indication of the decision(s) identified for reevaluation and the result of such reevaluation (e.g., a revised decision based on the responses from individuals 102 after being notified as discussed herein).

In some embodiments, such a determination is based on determining that a factor statement 412 is incorrect (e.g., widgets cost more than $10) or out-of-date (e.g., the price of widgets was $10 at the time of the meeting 100, but the current price of widgets is more than $10). In response to determining that a factor statement 412 is incorrect or out-of-date, in various embodiments factor statement reevaluation module 430 is configured to revise the factor statement 412 to reflect the correct or current version of factor statement 412. Similarly, in embodiments where a factor statement 412 is a research request, factor statement reevaluation module 430 may determine information responsive to the research request and revising the factor statement 412 accordingly. In response to revising the factor statement 412, factor statement reevaluation module 430 is also configured to determine, by examining meeting metadata 422, which meetings 100 are associated with decisions that were made based on the revised factor statement 412. Having identified such meeting meetings 100, in various embodiments factor statement reevaluation module 430 is configured to do one or more of: (1) generating a report to one or more individuals 102 who attended such meetings 100 including a prompt to revisit the decision, (2) add and/or remove audio or visual information to and/or from the encrypted recordings 134 associated with such meetings 100 to reflect the revision to the factor statement 412 (e.g., correct an incorrect factual statement, fulfill a research request), or (3) revising meeting metadata 422 associated with such meetings 100 to show that one of the factors statements 412 discussed in such meetings 100 has been revised. In various embodiments, the report includes the factor statement 412, additional information indicating that the factor statement 412 is incorrect or out-of-date, and a prompt to revisit the decision made at meeting 100.

Accordingly, in embodiments a computer system 120 (integrated with a computer system 400 or working with a computer system 400) may be used to receive a recording 110 (including audio of the meeting 100) of at least a portion of a meeting 100 between a plurality of individuals 102 and perform a semantic analysis on the recording 110 identify a decision statement and one or more factor statements 412 made at the meeting 100. In such embodiments, the recording 110 can be encrypted according to encryption policy 132 and stored as encrypted recording 134. In such embodiments, computer system 400 stores meeting metadata 422 associated with the encrypted recording 134 in a data store 420 that includes meeting metadata 422 associated with a plurality of encrypted recordings 134 associated with other meetings 100 of the enterprise. In such embodiments, the meeting metadata 422 is indicative of the decision statement and the one or more factor statements 412 associated with the meeting 100. In such embodiments, computer system 400 analyze meeting metadata 422 associated with the encrypted recordings 134 to determine whether factor statements 412 associated with the encrypted recordings 134 have been reevaluated subsequent to the respective meetings 100. In such embodiments, computer system 400 determines one or more encrypted recordings 134 corresponding to the reevaluated factors statements 412 and outputs an identification of the decision statements associated with the determined encrypted recordings 134.

FIGS. 5, 6, 7A, and 7B illustrate various flowcharts representing various disclosed methods implemented with computer system 120 and/or computer system 400. Referring now to FIG. 5, a flowchart illustrating a flowchart illustrating an embodiment of an encrypted meeting decryption method 500 is shown. In various embodiments, the various actions associated with method 500 are performed with computer system 120. At block 502, computer system 120 stores, an encrypted recording 134 of at least a portion of a meeting 100 between a plurality of individuals 102. As discussed herein, ones of the plurality of individuals 102 have previously been identified by computer system 120 and the encrypted recording 134 was encrypted according to a cryptographic policy 132. At block 504, computer system 120 receives decryption information indicative of ones of the plurality of individuals 102 that have assented to decryption of the encrypted recording 134. At block 506, computer system 120 determines, based on the decryption information and the cryptographic policy 132, that the encrypted recording 134 is to be decrypted. At block 508, in response to the determining, computer system 120 decrypt the encrypted recording 134.

Referring now to FIG. 6, a flowchart illustrating a meeting analysis, encryption, and decryption method 600 is shown. In various embodiments, computer system 120 executes computer-readable instructions that when executed cause computer system 120 to perform the various operations associated with method 600. At block 602, computer system 120 receive a recording 110 of at least a portion of a meeting 100 between a plurality of individuals 102. In various embodiments, the recording 110 includes audio. At block 604, computer system 120 performs a semantic analysis of the recording 110 to identify a decision statement and one or more factor statements made at the meeting 100. In various embodiments, the semantic analysis indicates that the decision statement is based on the one or more factor statements. At block 606, computer system 120 encrypts the recording 110 according to a cryptographic policy 132. At block 608, computer system 120 stores the encrypted recording 134. At block 610, computer system 120 receives decryption information indicative of ones of the plurality of individuals 102 that have assented to decryption of the encrypted recording 134. At block 612, computer system 120 determines, based on the decryption information and the cryptographic policy 132, that the encrypted recording 134 is to be decrypted. At block 614, in response to the determining, computer system 120 decrypt the encrypted recording 134

Referring now to FIGS. 7A and 7B, a flowchart illustrating a meeting decision statement reevaluation method 700 is shown. In various embodiments, the various actions associated with method 700 are performed with computer system 120 and computer system 400. As discussed herein, in some embodiments, computer system 120 and computer system 400 may be integrated into the same computer system. Alternatively, computer system 120 and computer system 400 may be implemented on separate computer systems that work together to perform the various actions associated with method 700. At block 702, computer system 120 receives a recording 110 of at least a portion of a meeting 100 between a plurality of individuals 102. In various embodiments, the recording 110 includes audio. At block 704, computer system 120 performs a semantic analysis of the recording 110 to identify a decision statement and one or more factor statements 412 made at the meeting 100. In various embodiments, the semantic analysis indicates that the decision statement is based on the one or more factor statements 412. At block 706, computer system 120 encrypts the recording 110 according to a cryptographic policy 132. At block 708, computer system 120, stores the encrypted recording 134 in an enterprise library that includes a plurality of encrypted recordings 134 associated with other meetings 100 of the enterprise. At block 710, computer system 400 stores meeting metadata 422 associated with the encrypted recording 134 in a data store 420 that includes meeting metadata 422 associated with a plurality of encrypted recordings 134 associated with other meetings 100 of the enterprise. In various embodiments, the meeting metadata 422 is indicative of the decision statement and the one or more factor statements 412 associated with the meeting 100. At block 712, computer system 400 analyzing meeting metadata 422 associated with the plurality of encrypted recordings 134 to determine whether any factor statements 412 associated with the plurality of encrypted recordings 134 have been subsequently been reevaluated. At block 714, computer system 400 determines one or more encrypted recordings 134 corresponding to the reevaluated factor statements 412. At block 716, computer system 400 outputs an identification of the decision statements associated with the determined one or more encrypted recordings 134.

### Exemplary Computer System

Turning now to FIG. 8, a block diagram of an exemplary computer system 800, which may implement the various components of computer system 120 and computer system 400, is depicted. Computer system 800 includes a processor subsystem 880 that is coupled to a system memory 820 and I/O interfaces(s) 840 via an interconnect 860 (e.g., a system bus). I/O interface(s) 840 is coupled to one or more I/O devices 850. Computer system 800 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 800 is shown in FIG. 8 for convenience, system 800 may also be implemented as two or more computer systems operating together.

Processor subsystem 880 may include one or more processors or processing units. In various embodiments of computer system 800, multiple instances of processor subsystem 880 may be coupled to interconnect 860. In various embodiments, processor subsystem 880 (or each processor unit within 880) may contain a cache or other form of on-board memory.

System memory 820 is usable to store program instructions executable by processor subsystem 880 to cause system 800 perform various operations described herein. System memory 820 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 800 is not limited to primary storage such as memory 820. Rather, computer system 800 may also include other forms of storage such as cache memory in processor subsystem 880 and secondary storage on I/O Devices 850 (e.g., a hard drive, storage array, etc.). In some embodiments, these other forms of storage may also store program instructions executable by processor subsystem 880.

I/O interfaces 840 may be any of various types of interfaces configured to couple to and communicate with other devices, according to various embodiments. In one embodiment, I/O interface 840 is a bridge chip (e.g., Southbridge) from a front-side to one or more back-side buses. I/O interfaces 840 may be coupled to one or more I/O devices 850 via one or more corresponding buses or other interfaces. Examples of I/O devices 850 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 800 is coupled to a network via a network interface device 850 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method comprising:
storing, by a computer system, an encrypted recording of at least a portion of a meeting between a plurality of individuals, wherein ones of the plurality of individuals have previously been identified by the computer system, and wherein the encrypted recording was encrypted according to a cryptographic policy;
receiving, at the computer system, decryption information indicative of ones of the plurality of individuals that have assented to decryption of the encrypted recording;
determining, by the computer system based on the decryption information and the cryptographic policy, that the encrypted recording is to be decrypted; and
in response to the determining, decrypting the encrypted recording.

2. The method of claim 1, wherein the decryption information is stored in a blockchain-based shared ledger.

3. The method of claim 2, wherein respective computer systems associated with ones of the plurality of individuals validate the blockchain-based shared ledger before transmitting decryption information, from the respective one of the plurality of individuals, indicative of whether the respective one of the plurality of individuals have assented to decryption of the encrypted recording.

4. The method of claim 2, further comprising:
receiving, at the computer system, a request to change the encrypted recording;
evaluating, with the computer system, the requested change according to the cryptographic policy; and
recording, with the computer system, information about the requested change in the blockchain-based shared ledger.

5. The method of claim 1, wherein the cryptographic policy specifies that a majority of the plurality of individuals must have assented to decryption as a criterion for the determining.

6. The method of claim 1, wherein the plurality of individuals includes one or more key individuals and wherein the cryptographic policy specifies that one or more of the key individuals must have assented to decryption as a criterion for the determining.

7. The method of claim 1, wherein the recording of the meeting was created at the request of a first individual of the plurality of individuals and wherein the cryptographic policy specifies that the first individual must have assented to decryption as a criterion for the determining.

8. The method of claim 1, wherein the plurality of individuals includes a first individual and a second individual, the method further comprising:
determining, with the computer system, first individual portions of the encrypted recording, wherein the first individual portions include one or more portions of the encrypted recording during which the first individual spoke; and
analyzing, with the computer system, second individual portions of the encrypted recording, wherein the second individual portions include one or more portions of the encrypted recording during which the second individual spoke.

9. The method of claim 8, further comprising:
determining, with the computer system, to remove the second individual portions from the encrypted recording; and
revising, with the computer system, the encrypted recording by removing the second individual portions from the encrypted recording according to the cryptographic policy.

10. The method of claim 8,
wherein the encrypted recording includes an encrypted version of the first individual portion;
wherein determining that the encrypted recording is to be decrypted includes determining that decryption information indicative of whether the first individual has assented to decryption of the encrypted recording has been received; and
wherein decrypting the encrypted recording includes decrypting the encrypted version of the first individual portion.

11. The method of claim 8,
wherein the encrypted recording includes an encrypted version of the first individual portion;
where determining that the encrypted recording is to be decrypted includes determining that decryption information indicative of whether the first individual has assented to decryption of the encrypted recording has not been received; and
wherein decrypting the encrypted recording includes decrypting other portions of the encrypted recording but not decrypting the encrypted version of the first individual portion.

12. The method of claim 1, wherein the encrypted recording includes visual information synced with audio.

13. The method of claim 1, further comprising:
storing, by the computer system, metadata generated as a result of a semantic analysis of audio of the meeting to identify a decision statement made at the meeting and one or more factor statements made at the meeting, wherein the semantic analysis indicates that the decision statement is based on the one or more factor statements;
subsequent to the meeting, analyzing, with the computer system, one or more data stores to identify additional information indicating that one or more factor statements is incorrect; and
in response to identifying the additional information, generating a report for one of more of the individuals based on the one or more factor statements, additional information, and decision statement, wherein the report includes a prompt to revisit the decision.

14. A non-transitory, computer-readable medium storing instructions that when executed by a computer system cause the computer system to perform operations comprising:
receiving, at the computer system, a recording of at least a portion of a meeting between a plurality of individuals, wherein the recording includes audio;
performing, with the computer system, a semantic analysis of the recording to identify a decision statement and one or more factor statements made at the meeting, wherein the semantic analysis indicates that the decision statement is based on the one or more factor statements;
encrypting, with the computer system, the recording according to a cryptographic policy;
storing, by the computer system, the encrypted recording;
receiving, at the computer system, decryption information indicative of ones of the plurality of individuals that have assented to decryption of the encrypted recording;
determining, by the computer system based on the decryption information and the cryptographic policy, that the encrypted recording is to be decrypted; and
in response to the determining, decrypting the encrypted recording.

15. The non-transitory, computer-readable medium of claim 14, wherein performing the semantic analysis includes determining that one or more factor statements is a factual statement made by an individual during the meeting; the operations further comprising:
subsequent to the meeting, analyzing, with the computer system, one or more data stores to identity additional information indicating that the factual statement is incorrect; and
revising, with the computer system and according to the cryptographic policy, the encrypted recording to correct the incorrect factual statement.

16. The non-transitory, computer-readable medium of claim 14, wherein performing the semantic analysis includes identifying, with the computer system, a research request made by an individual during the meeting, the operations further comprising:
subsequent to the meeting, analyzing, with the computer system, one or more data stores to identity additional information responsive to the research request; and
revising, with the computer system and according to the cryptographic policy, the encrypted recording to include the additional information.

17. The non-transitory, computer-readable medium of claim 14, wherein the operations further comprise:
subsequent to the meeting, analyzing, with the computer system, one or more data stores to identity additional information indicating that one or more factor statements is incorrect; and
in response to identifying the additional information, generating a report for one of more of the individuals based on the one or more factor statements, additional information, and decision statement, wherein the report includes a prompt to revisit the decision statement.

18. A method comprising:
receiving, at a computer system of an enterprise, a recording of at least a portion of a meeting between a plurality of individuals, wherein the recording includes audio;
performing, with the computer system, a semantic analysis of the recording to identify a decision statement and one or more factor statements made at the meeting, wherein the semantic analysis indicates that the decision statement is based on the one or more factor statements;
encrypting, with the computer system, the recording according to a cryptographic policy;
storing, by the computer system, the encrypted recording in an enterprise library that includes a plurality of encrypted recordings associated with other meetings of the enterprise;
storing, by the computer system, meeting metadata associated with the encrypted recording in a data store that includes meeting metadata associated with a plurality of encrypted recordings associated with other meetings of the enterprise, wherein the meeting metadata is indicative of the decision statement and the one or more factor statements associated with the meeting;
analyzing, by the computer system, meeting metadata associated with the plurality of encrypted recordings to determine whether any factor statements associated with the plurality of encrypted recordings have been subsequently been reevaluated;
determining, by the computer system, one or more encrypted recordings corresponding to the reevaluated factor statements; and
outputting, by the computer system, an identification of the decision statements associated with the determined one or more encrypted recordings.

19. The method of claim 18,
wherein the analyzing includes determining that a factor statement made at a first meeting and at a second meeting is factually incorrect;
wherein the determining includes determining that a first encrypted recording and a second encrypted recording correspond to the factually incorrect factor statement; and
wherein the outputting includes outputting an indication of the decision statements associated with the first encrypted recording and the second encrypted recording.

20. The method of claim 18 further comprising:
subsequent to the meeting, analyzing, with the computer system, one or more data stores to identity additional information indicating that one or more factor statement should be reevaluated;
reevaluating, with the computer system, the one or more identified factor statements to determine whether meeting metadata associated with ones of the plurality of encrypted recordings should be revised; and
based on the reevaluating, updating meeting metadata associated ones of the plurality of encrypted recordings.
